(19) United States
(12) Patent Application Publication
(10) Pub. No.: US 2012/0280966 A1
(43) Pub. Date: Nov. 8, 2012

(54) DISPLAY DRIVER AND FLICKER SUPPRESSION DEVICE THEREOF

(75) Inventors: Chien-Ming Chen, Tainan City (TW); Hui-Wen Miao, Hsinchu City (TW); Ko-Yang Tso, New Taipei City (TW)

(73) Assignee: RAYDIUM SEMICONDUCTOR CORPORATION, Hsinchu (TW)

(21) Appl. No.: 13/439,065

(22) Filed: Apr. 4, 2012

(30) Foreign Application Priority Data
May 3, 2011 (TW) 100115526

(51) Int. Cl. G09G 5/00

(52) U.S. Cl. 345/212

(57) ABSTRACT

A flicker suppression device applied in a display driver for preventing the output image data of the display driver from being affected by an electrostatic discharge (ESD) event is provided. The flicker suppression device includes an ESD detector and an output stage controller. The ESD detector is coupled to a first power wire of the display driver for determining whether an ESD level shift event occurs to the first system reference voltage signal on the first power wire. If so, a control signal corresponding to the first level is provided. The output stage controller controls the output stage circuit of the display driver to be in a high impedance state in response to the control signal corresponding to the first level to avoid the output stage circuit outputting an output image data that has been affected by an ESD event.

This application claims the benefit of Taiwan application Serial No. 100115526, filed May 3, 2011, the subject matter of which is incorporated herein by reference.

### BACKGROUND OF THE INVENTION

1. Field of the Invention

The invention relates in general to a display driver and a flicker suppression device thereof, and more particularly to a display driver preventing the display data of the display driver from being affected by electrostatic discharge (ESD) event and a flicker suppression device thereof.

2. Description of the Related Art

With the rapid advance in technology, the integrated circuit (IC) has been widely applied in various occasions for providing convenience to people in their everydayness. In general, the integrated circuit (IC) is easily affected by electrostatic discharge (ESD), and may end up with operation abnormality or even be damaged. For example, the ESD may be caused by the user's ESD which arises from friction or from sensing and touching the terminal of an integrated circuit (such as facility control) or the casing of a circuit device.

In the applications of the display driver, the ESD event may even cause the system reference voltage level (such as system high reference voltage level VDD and system low reference voltage level VSS) to shift, and make the frame of the display driven by the display driver flickering. Therefore, how to provide a mechanism frame flickering suppression for the display has become a prominent task for the industries.

### SUMMARY OF THE INVENTION

The invention is directed to a flicker suppression device applied in a display driver. The flicker suppression device includes an electrostatic discharge (ESD) detector for determining whether an ESD level shift event occurs to a system reference voltage signal, and correspondingly providing a control signal. The flicker suppression device of the invention further includes an output stage controller, which selectively controls the output stage circuit of the display driver to be in a high impedance state according to the control signal to avid the image data PV outputted to the LCD being affected by an ESD event. In comparison to the conventional display driver, the flicker suppression device of the invention has the advantage of effectively avoiding frame flickering or other display problems occurring to the display frame of the corresponding LCD.

According to a first aspect of the present invention, a flicker suppression device applied in a display driver for preventing the output image data of the display driver from being affected by an electrostatic discharge (ESD) event is provided. The flicker suppression device includes an ESD detector and an output stage controller. The ESD detector is coupled to a first power wire of the display driver for determining whether an ESD level shift event occurs to the first system reference voltage signal on the first power wire. If so, a control signal corresponding to the first level is provided. The output stage controller controls the output stage circuit of the display driver to be in a high impedance state in response to the control signal corresponding to the first level to avoid the output stage circuit outputting an output image data that has been affected by an ESD event.

According to a second aspect of the present invention, a display driver is provided. The display driver includes a first power wire, a drive device and a flicker suppression device. The first power wire provides a first system reference voltage signal. The drive device includes an output stage circuit with which the drive device outputs an output image data in response to an input image data. The flicker suppression device is coupled to the output stage circuit for preventing the output image data from being affected by an ESD event. The flicker suppression device includes an ESD detector and an output stage controller. The ESD detector is coupled to a first power wire of the display driver for determining whether an ESD level shift event occurs to the first system reference voltage signal on the first power wire. If so, a control signal corresponding to the first level is provided. The output stage controller controls the output stage circuit of the display driver to be in a high impedance state in response to the control signal corresponding to the first level to avoid the output stage circuit outputting an output image data that has been affected by an ESD event.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of a display driver according to one embodiment of the invention;

FIG. 2 shows a relevant signal timing diagram of a flicker suppression device according to one embodiment of the invention;

FIG. 3 shows a block diagram of a flicker suppression device according to one embodiment of the invention;

FIG. 4 shows another relevant signal timing diagram of a flicker suppression device according to one embodiment of the invention; and

FIG. 5 shows another block diagram of a flicker suppression device according to one embodiment of the invention.

### DETAILED DESCRIPTION OF THE INVENTION

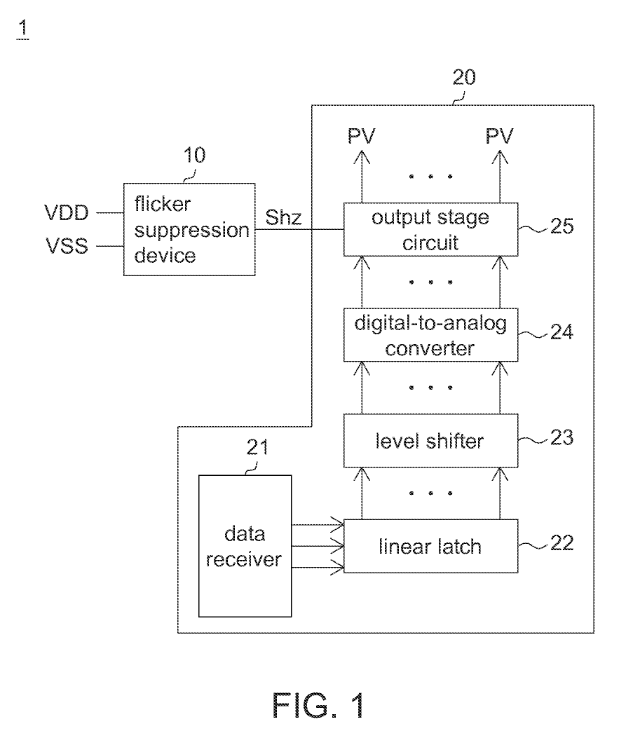

Referring to FIG. 1, a block diagram of a display driver according to one embodiment of the invention is shown. The display driver 1 is for driving a liquid crystal display (LCD) (not illustrated), and includes a first power wire, a second power wire, a drive device 20 and a flicker suppression device 10. The first and the second power wire respectively provide system reference voltage signals VDD and VSS for powering the display driver 1.

The drive device 20, such as applied in the data driver of an LCD, is realized by an integrated circuit (IC). For example, the drive device 20 includes a data receiver 21, a linear latch 22, a level shifter 23, a digital-to-analog converter 24 and an output stage circuit 25. The level shifter 23, the digital-to-analog converter 24 and the output stage circuit 25 form a plurality of pixel data channels for outputting an output image data PV corresponding to a plurality of pixel columns. The linear latch 22 receives and buffers the digital data provided by the data receiver 21. The linear latch 22 further provides each digital data to its corresponding pixel data channel.

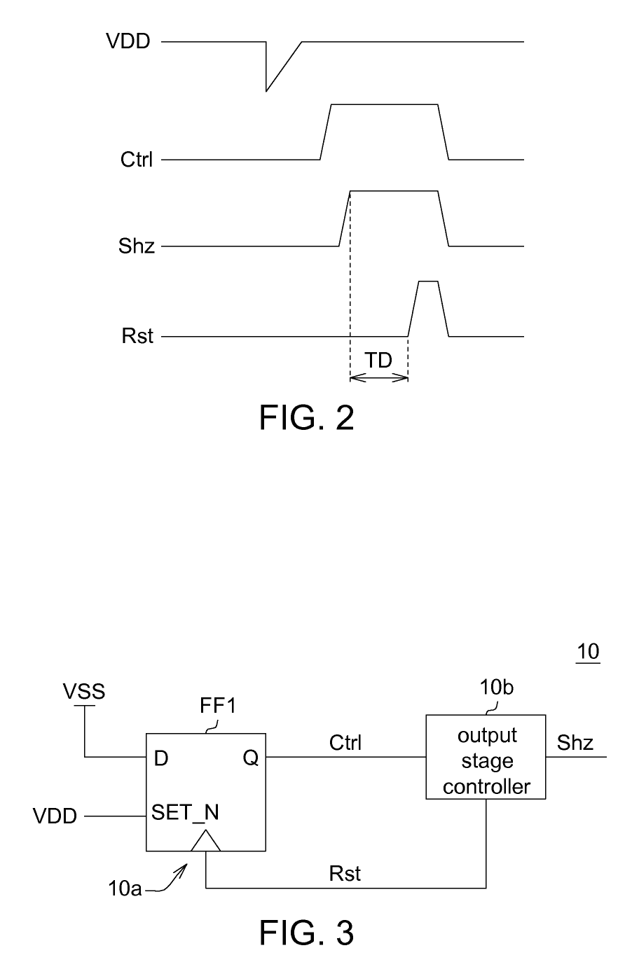

In an operation example, the electrostatic discharge (ESD) event occurring to the power wire correspondingly causes level shift to the system reference voltage signal VDD as indicated in the signal timing diagram of FIG. 2. The above shift of the system reference voltage signal VDD correspondingly causes error to the data buffered in the linear latch 22 and makes the display frame of the LCD flickering.

Referring to FIG. 3, a block diagram of a flicker suppression device according to one embodiment of the invention is shown. In an example, the display driver 1 includes a flicker suppression device 10 for suppressing frame flickering caused by an ESD event. The flicker suppression device 10 includes an ESD detector 10a and an output stage controller 10b.

The ESD detector 10a is coupled to a power wire of the display driver 1 for receiving the system reference voltage signal VDD. The ESD detector 10a further determines whether an ESD level shift event occurs to the system reference voltage signal VDD. For example, the ESD level shift event is a level stepping down event occurring to the system reference voltage signal VDD as indicated in FIG. 2. When an ESD level shift event occurs to the system reference voltage signal VDD, the ESD detector 10a provides a control signal Ctrl corresponding to the first level such as a high signal level.

In an embodiment, the ESD detector 10a can be realized by a flip-flop FF1, wherein the input pin, the output pin and the setting pin of the flip-flop FF1 respectively receive the system reference voltage signal VSS, outputs the control signal Ctrl and receives the system reference voltage signal VDD. The setting pin is such as a low voltage triggering pin, and when the system reference voltage signal VDD is shifted to a low voltage level due to an ESD level shift event, the flip-flop FF1 correspondingly outputs a control signal Ctrl corresponding to a high voltage level.

The output stage controller 10 provides an enabled output termination signal Shz for controlling the output stage circuit 25 of the display driver 1 to be in a high impedance state in response to the control signal corresponding to the first level Ctrl to correspondingly avoid the output stage circuit 25 outputting an output image data PV that has been affected by an ESD event. In an embodiment, the output stage controller 10b further outputs a resetting signal Rst for controlling the ESD detector 10a to reset the control signal Ctrl to a second level such as a low voltage level after the output stage circuit 25 has been in a high impedance state for delay time TD.

Thus, the flicker suppression device can control the output stage circuit 25 to enter a high impedance state when an ESD event occurs so as to avoid the image data PV outputted to the LCD being affected by the ESD event.

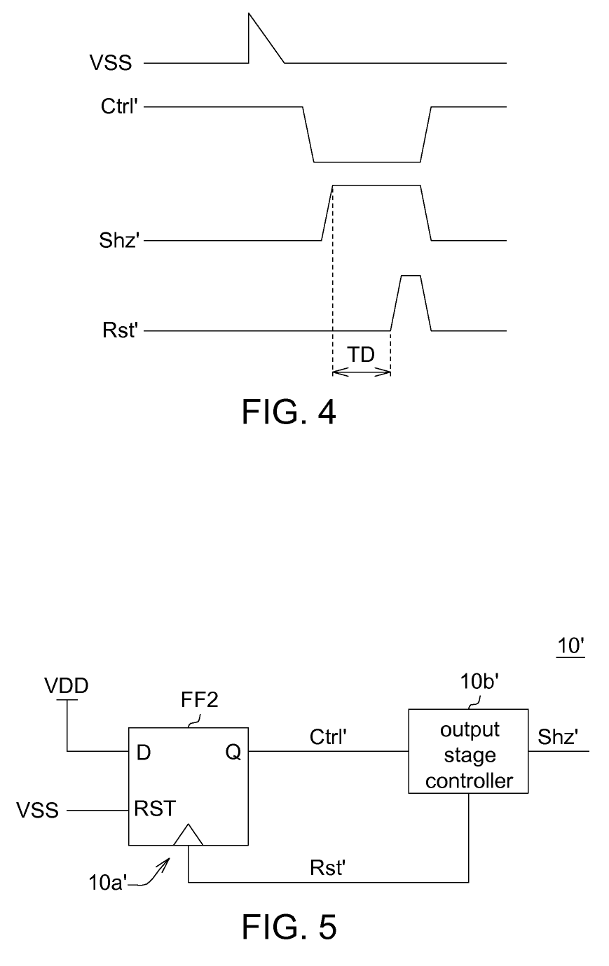

In the present embodiment of the invention, the operation of the flicker suppression device 10 is exemplified by level shift detection performed on the system reference voltage signal VDD. However, the flicker suppression device 10 of the present embodiment of the invention is not limited thereto. In other examples, the flicker suppression device 10 can also detect level shift on the reference voltage signal VSS as indicated in FIG. 4 and FIG. 5.

In the present embodiment of the invention, the operation of the flicker suppression device 10 is exemplified by a level shift detection performed on the system reference voltage signal VDD. However, the flicker suppression device 10 of the present embodiment of the invention is not limited thereto. In other examples, the ESD detector 10a of the flicker suppression device 10 can also be disposed next to the linear latch 22 for detecting level shift on the system reference voltage signals VDD′ and VSS′ on the system reference voltage signal pad of the linear latch 22.

In the present embodiment of the invention, the flicker suppression device 10 includes an ESD detector 10a. However, the flicker suppression device 10 of the present embodiment of the invention is not limited thereto. In other examples, the flicker suppression device 10 may include two or more than two ESD detectors for detecting ESD on two or more than two system reference voltage signals (such as the same system reference voltage signal VDD on different nodes or different system reference voltage signals VDD and VSS). The output stage controller correspondingly includes a logic OR gate for performing logic OR operation on the control signal provided by the two or more than two ESD detectors and accordingly providing an output termination signal Shz and a resetting signal Rst.

The flicker suppression device of the present embodiment of the invention is applied in a display driver for suppressing frame flickering. The flicker suppression device of the present embodiment of the invention includes an ESD detector for determining whether an ESD level shift event occurs to the system reference voltage signal, and correspondingly providing a control signal. The flicker suppression device of the present embodiment of the invention further includes an output stage controller, which selectively controls the output stage circuit of the display driver to be in a high impedance state according to the control signal to avoid the image data PV outputted to the LCD being affected by an ESD event. In comparison to the conventional display driver, the flicker suppression device of the invention has the advantage of effectively avoiding frame flickering or other display problems occurring to the display frame of the corresponding LCD.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A flicker suppression device applied in a display driver for preventing an output image data of the display driver from being affected by an electrostatic discharge (ESD) event, wherein the flicker suppression device comprises:
an ESD detector coupled to a first power wire of the display driver for determining whether an ESD level shift event occurs to the first system reference voltage signal on the first power wire, and when the ESD level shift event occurs to the first system reference voltage signal, the ESD detector provides a control signal corresponding to a first level; and
an output stage controller for controlling an output stage circuit of the display driver to be in a high impedance state in response to the control signal corresponding to the first level to avoid the output stage circuit outputting an output image data that has been affected by an ESD event.

2. The flicker suppression device according to claim 1, wherein the output stage controller further outputs a resetting signal for controlling the ESD detector to reset the control signal to a second level after the output stage circuit has been in the high impedance state for a delay time.

3. The flicker suppression device according to claim 2, wherein the ESD detector comprises:
a sampling circuit comprising an input pin, a setting pin, a driving pin and an output pin respectively used for receiving a reference signal, the first system reference voltage signal, receiving the resetting signal and providing a control signal;
wherein, the sampling circuit controls the output pin to correspond to the first level in response to the first system reference voltage signal to which the ESD level shift event occurs;
wherein, the sampling circuit sets the control signal to correspond to the second level in response to the resetting signal.

4. The flicker suppression device according to claim 3, wherein the reference signal is a second system reference voltage signal on a second power wire of the display driver.

5. The flicker suppression device according to claim 3, wherein the reference signal is a power supply signal of a data register of the display driver.

6. A display driver, comprising:
a first power wire for providing a first system reference voltage signal;
a drive device comprising an output stage circuit, wherein the drive device outputs an output image data with the output stage circuit in response to an input image data; and
a flicker suppression device coupled to the output stage circuit for preventing the output image data from being affected by an ESD event, wherein the flicker suppression device comprises:
an ESD detector coupled to the first power wire for determining whether an ESD level shift event occurs to the first system reference voltage signal, wherein the ESD detector provides a control signal corresponding to a first level when the ESD level shift event occurs to the first system reference voltage signal; and
an output stage controller for controlling the output stage circuit to be a high impedance state in response to the control signal corresponding to the first level to avoid the output stage circuit outputting an output image data that has been affected by an ESD event.

7. The display driver according to claim 6, wherein the output stage controller further outputs a resetting signal for controlling the ESD detector to reset the control signal to a second level after the output stage circuit has been in the high impedance state for a delay time.

8. The display driver according to claim 7, wherein the ESD detector comprises:
a sampling circuit comprising an input pin, a setting pin, a driving pin and output pin respectively used for receiving a reference signal, the first system reference voltage signal, receiving the resetting signal and providing a control signal;
wherein, the sampling circuit controls the output pin to correspond to the first level in response to the first system reference voltage signal to which the ESD level shift event occurs;
wherein, the sampling circuit sets the control signal to correspond to the second level in response to the resetting signal.

9. The display driver according to claim 8, further comprising:
a second power wire for providing a second system reference voltage signal;
wherein, the reference signal is the second system reference voltage signal on the second power wire.

10. The display driver according to claim 8, further comprising:
a data register;
wherein, the reference signal is a power supply signal of the data register.
